(19) United States
(12) Patent Application Publication
(10) Pub. No.: US 2013/0033014 A1
(43) Pub. Date: Feb. 7, 2013

(54) TOOL CART

(71) Applicant: CHENG-CHIANG YANG, Taichung City (TW)

(72) Inventor: CHENG-CHIANG YANG, Taichung City (TW)

(21) Appl. No.: 13/196,903

(22) Filed: Aug. 3, 2011

(51) Int. Cl. B62B 3/00

(52) U.S. Cl. 280/47.35

(57) ABSTRACT

A tool cart includes at least one box, multiple posts, a hanging rod, a wire wrapping member and multiple wheel sets which are connected to the lower ends of the posts. The at least one box has least one set of assembling holes defined in one of outsides thereof. The multiple posts are connected to the at least one box and each has a connection portion located at an inside thereof. The hanging rod is connected between the connection portions of two adjacent posts. The wire wrapping member is connected to the at least one set of the assembling holes and wires are wrapped around the wire wrapping member. A paper towel is connected to the hanging rod.

### FIELD OF THE INVENTION

The present invention relates to a tool cart, and more particularly, to a tool cart with two parts for wrapping wires and paper towel.

### BACKGROUND OF THE INVENTION

Modern electric appliances enrich our life and the maintenance for these appliances is necessary for the users so that different types of tools are developed for the maintenance purposes. The tools are usually stored in a tool box which is cooperated with a tool cart so that the users can move the tool cart conveniently. However, the tools are put in the tool box randomly so that it takes a lot of time to find out the tools needed. Besides, the conventional tool cart does not have proper position to organize the wires and paper towels.

When the tools are long or bulky, they may protrude beyond the tool cart and may drop off from the tool cart by people passing by. Some parts are tiny and may be hidden by large tools so that the users have to remove some parts to find them. Although some users use small boxes to store the tiny parts, the small boxes occupy the limited space of the tool cart.

Some tool carts are equipped with storage boxes for the tiny parts, but if the users do not need the storage boxes, the storage boxes become useless and occupy space. Most of the tool carts are made to avoid the boxes from being separated from the carts so that the uses cannot to adjust the number of the boxes.

The present invention intends to provide a tool cart which has a wire wrapping member and a rod for respectively organize wires and paper towel. The organization boxes can be added or removed from the tool cart.

### SUMMARY OF THE INVENTION

The present invention relates to a tool cart and comprises at least one box, multiple posts, a hanging rod, a wire wrapping member and multiple wheel sets which are connected to the lower ends of the posts. The at least one box has at least one set of assembling holes defined in one of outsides thereof. The multiple posts are connected to the at least one box and each has a connection portion located at an inside thereof. The hanging rod is connected between the connection portions of two adjacent posts. The wire wrapping member is connected to the at least one set of the assembling holes and wires are wrapped around the wire wrapping member. A paper towel is connected to the hanging rod.

Preferably, a tool rack is connected to the at least one box and has an engaging member which is engaged with multiple engaging slots defined in the outsides of the box.

Preferably, a handle is connected to the at least one box and has an engaging block. The at least one box includes multiple engaging slots defined in the outsides thereof and the engaging block is engaged with one of the engaging slots.

Preferably, the wire wrapping member is a T-shaped member and wires are wrapped around the wire wrapping member.

Preferably, each post has at least one protrusion located at the inside thereof and the at least one box has at least one connection hole defined therethrough. The at least one protrusion is inserted into the at least one connection hole.

Preferably, the number of the at least one protrusion is correspondingly adjusted by the number of the at least one box so that the number of the box can be adjusted.

The primary object of the present invention is to provide a tool cart which provides a wire wrapping member and a hanging rod, wherein the wires are wrapped around the wire wrapping member and the paper towel is connected to the hanging rod.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the tool cart of the present invention;

FIG. 2 is a perspective view to show the tool cart of the present invention;

FIG. 3 is a perspective view to show the first embodiment of the present invention;

FIG. 4 is a perspective view to show the second embodiment of the present invention;

FIG. 5 is a perspective view to show the third embodiment of the present invention;

FIG. 6 is a perspective view to show the fourth embodiment of the present invention, and

FIG. 7 is an enlarged view to show the operation status of the fourth embodiment of the tool cart of the present invention.

### DETAILED DESCRIPTION OF THE PREFERRED EMBODIMENT

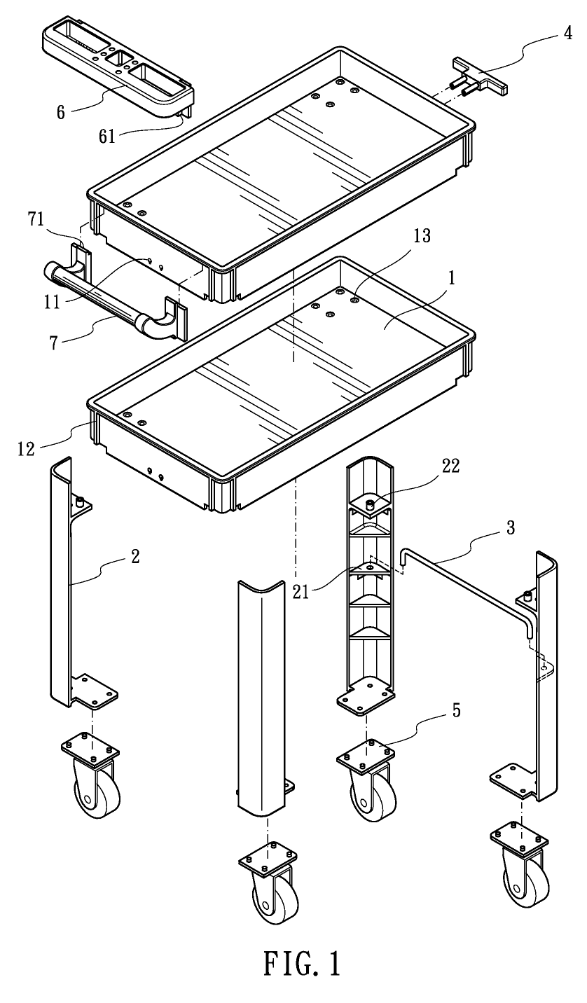

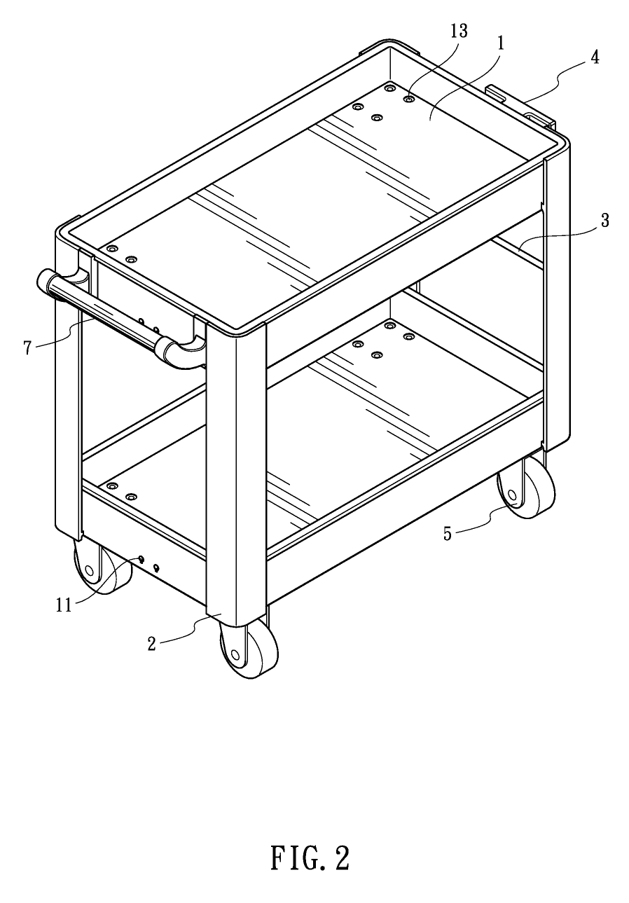

Referring to FIGS. 1 and 2, a tool cart of the present invention comprises at least one box 1, four posts 2, a hanging rod 3, a wire wrapping member 4, and four wheel sets 5. The box 1 has two assembling holes 11 defined in the two corresponding ends thereof so as to be connected with the wire wrapping member 4. The wire wrapping member 4 is a T-shaped member and when the wire wrapping member 4 is connected to the assembling holes 11, wires can be wrapped around the wire wrapping member 4 so as to prevent the wires from dropping from the tool cart. The four posts 2 are connected to the four corners of the box 1 and each post 2 has a connection portion 21 located at the inside thereof. The hanging rod 3 has two ends thereof connected between the connection portions 21 of two adjacent posts 2. Each post 2 has a protrusion 22 located at the inside thereof and the box 1 has four connection holes 13 defined through the underside of each of the four corners thereof. The protrusions 22 are inserted into the connection holes 13 to position the box 1 relative to the posts 2. The number of the protrusion 22 is correspondingly adjusted by the number of the box 1 so that multiple boxes 1 can be installed to the tool cart.

This embodiment further comprises a tool rack 6 and a handle 7. The tool rack 6 and the handle 7 respectively have an engaging member 61 and an engaging block 71 on their sides thereof. The box 1 includes an engaging slot 12 defined in the outside thereof and located close to the four corners where the posts 2 are located, so that the engaging member 61 and the engaging block 71 are engaged with the engaging slots 12. The engaging slots 12 allow the users to replace parts as needed. By the engagements between the engaging member 61 of the tool rack 6, the engaging block 71 of the handle 7 and the engaging slots 12, the tool cart has more accommodating space and easily moved. The four wheel sets 5 of the tool cart are respectively connected with the lower ends of the four posts to allow the users to move the tool cart as needed.

Referring to FIG. 2, which is the perspective view of the tool cart of the present invention, and FIG. 1 is also referred to, in this embodiment, according to the above-mentioned embodiment, four sides of the two boxes 1 are located corresponding to the four posts 2 and the lower end of each of the four posts 2 is connected with one wheel set 5 to form a complete tool cart. The two ends of the boxes 1 are connected to the handle 7 to let the tool cart easily be moved.

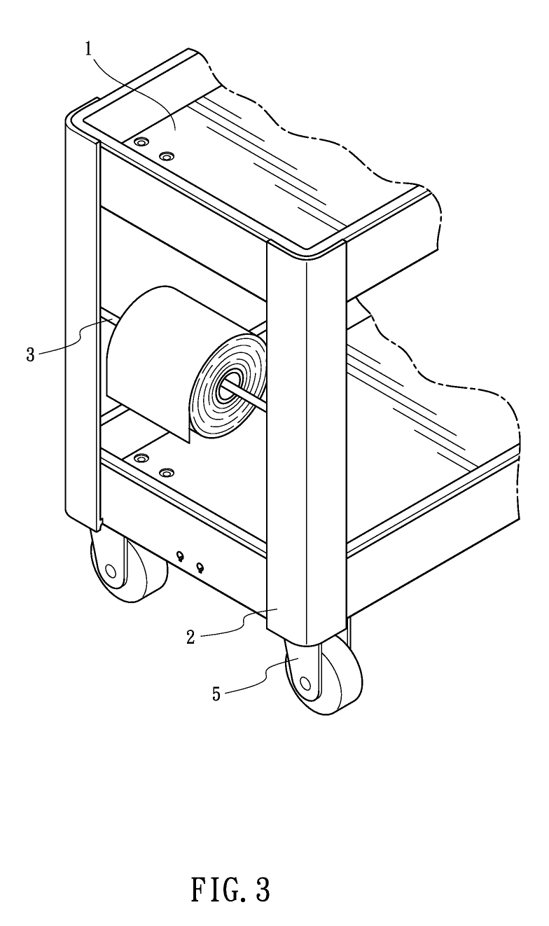

As shown in FIG. 3, which is the perspective view of the first embodiment, FIGS. 1 and 2 are also referred to, in this embodiment, according to the above-mentioned embodiment, four sides of the two boxes 1 are located corresponding to the four posts 2 and the lower end of each of the four posts 2 is connected with one wheel set 5 to form a complete tool cart. The posts 2 on the front-right end of the tool cart have the hanging rod 3 connected therebetween, and a paper towel is connected to the hanging rod 3.

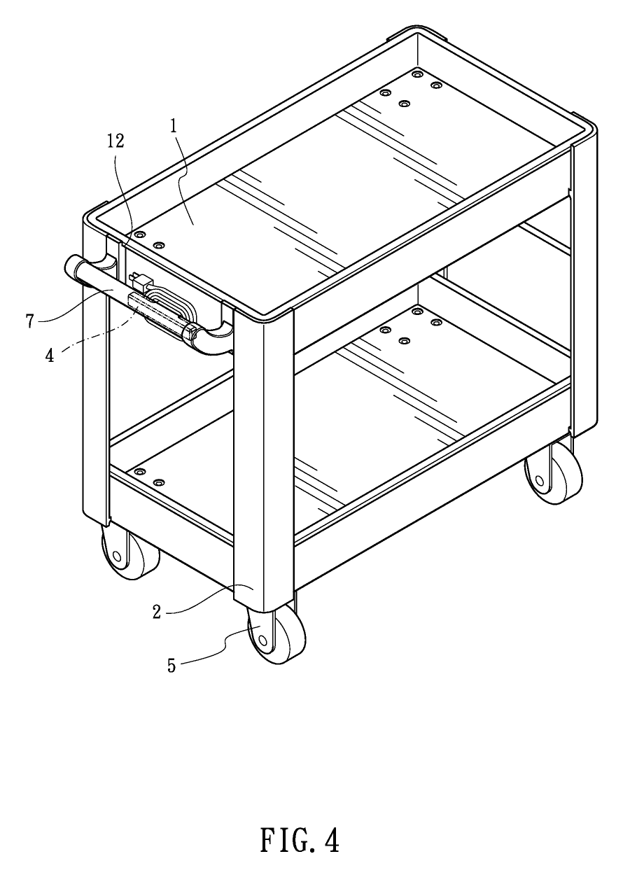

As shown in FIG. 4, which is the perspective view of the second embodiment, FIGS. 1 to 3 are also referred to, in this embodiment, according to the above-mentioned embodiment, four sides of the two boxes 1 are located corresponding to the four posts 2 and the lower end of each of the four posts 2 is connected with one wheel set 5 to form a complete tool cart. Besides the handle 7 connected to the engaging slots 12 defined at the end of the box 1 and the post 2, the wire wrapping member 4 is connected to the same outside as the handle 7 is connected, so that the tool cart of the embodiment is more easily moved and has the function of wrapping the wires.

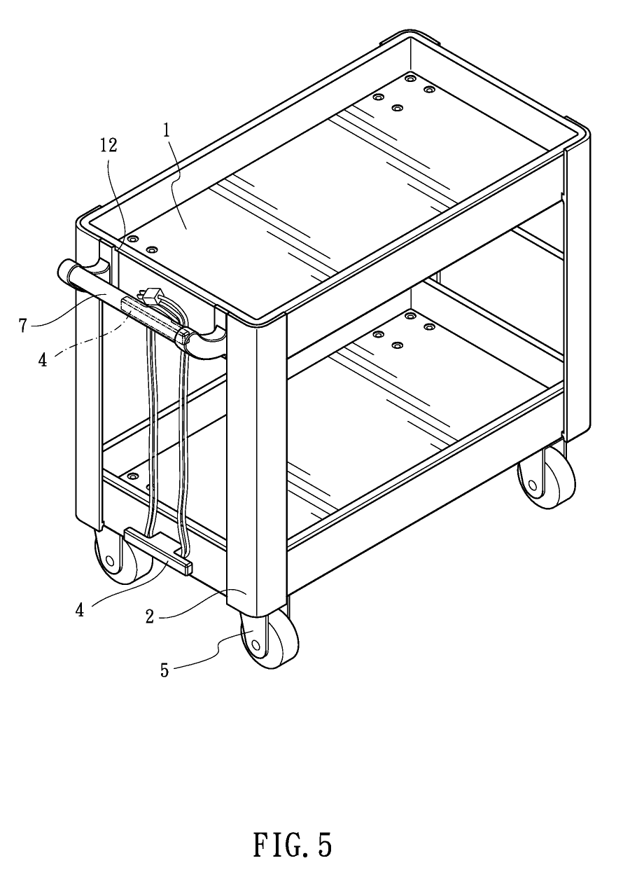

As shown in FIG. 5, which is the perspective view of the third embodiment, FIGS. 1 to 4 are also referred to, in this embodiment, according to the above-mentioned embodiment, four sides of the two boxes 1 are located corresponding to the four posts 2 and the lower end of each of the four posts 2 is connected with one wheel set 5 to form a complete tool cart. Besides the handle 7 connected to the engaging slots 12 defined at the end of the box 1 and the post 2, one wire wrapping member 4 is connected to the same left side as the handle 7 is connected, and another wire wrapping member 4 is connected to the end surface on the left of the box 1, so that the tool cart of the embodiment is more easily moved and the wires can be wrapped to the wire wrapping member 4 located at the upper box 1 and the wire wrapping member 4 located at the lower box 1.

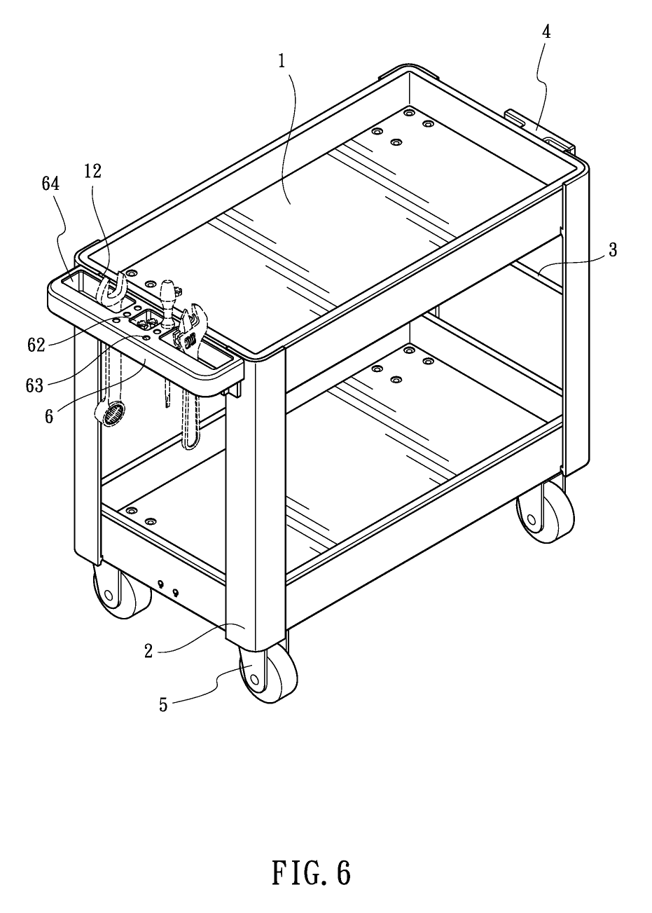

As shown in FIG. 6, which shows the perspective view of the fourth embodiment, FIGS. 1 to 5 are also referred to, in this embodiment, according to the above-mentioned embodiment, besides the hanging rod 3 and the wire wrapping member 4 are added, the tool rack 6 is connected to the engaging slots 12 defined at the end of the box 1 and the post 2 on the left. The tool rack 6 has a recess 62, two first holes 63 and two second holes 64 so as to receive the nuts, wrenches and screw drivers.

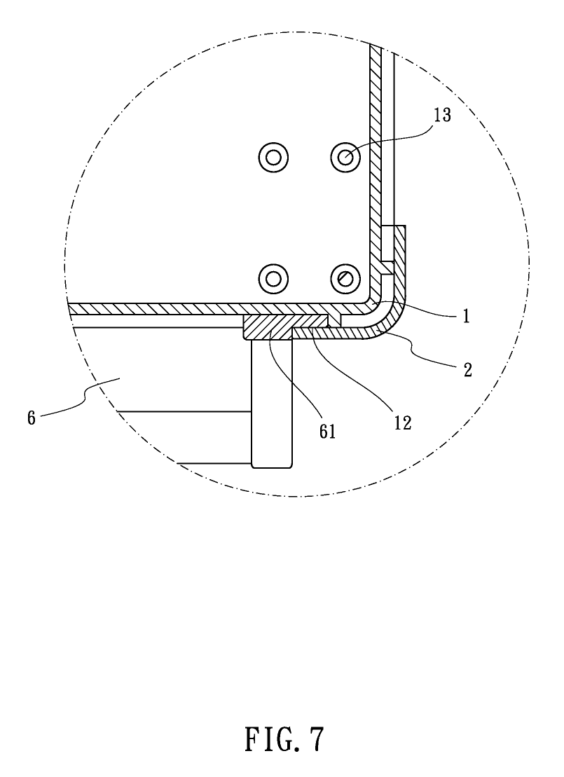

Referring to FIG. 7, which shows the enlarged view of show the operation status of the fourth embodiment of the tool cart of the present invention, FIGS. 1 to 6 are also referred to, in this embodiment, according to the above-mentioned embodiment, the connection relationship between the engaging member 61 of the tool rack 6 and the engaging slots 12 is revealed.

While we have shown and described the embodiment in accordance with the present invention, it should be clear to those skilled in the art that further embodiments may be made without departing from the scope of the present invention.

What is claimed is:

1. A tool cart comprising:
at least one box having at least one set of assembling holes defined in one of outsides thereof;
multiple posts connected to the at least one box and each having a connection portion located at an inside thereof;
a hanging rod connected between the connection portions of two adjacent posts;
a wire wrapping member connected to the at least one set of the assembling holes, and
multiple wheel sets connected to respective lower ends of the posts.

2. The tool cart as claimed in claim 1, wherein a tool rack is connected to the at least one box and has an engaging member, the at least one box includes multiple engaging slots defined in the outsides thereof and the engaging member is engaged with one of the engaging slots.

3. The tool cart as claimed in claim 1, wherein a handle is connected to the at least one box and has an engaging block, the at least one box includes multiple engaging slots defined in the outsides thereof and the engaging block is engaged with one of the engaging slots.

4. The tool cart as claimed in claim 1, wherein the wire wrapping member is a T-shaped member which is adapted to be wrapped by wires so as to obtain a function of preventing the wires from dropping from the tool cart.

5. The tool cart as claimed in claim 1, wherein each post has at least one protrusion located at the inside thereof and the at least one box has at least one connection hole defined therethrough, the at least one protrusion is inserted into the at least one connection hole so as to obtain a function of positioning the box.

6. The tool cart as claimed in claim 5, wherein a number of the at least one protrusion is correspondingly adjusted by a number of the at least one box so as to obtain a function of adjustment of the number of the at least one box.
